(19) United States
(12) Patent Application Publication
(10) Pub. No.: US 2026/0025470 A1
(43) Pub. Date: Jan. 22, 2026

(54) NON-TRANSITORY COMPUTER-READABLE STORAGE MEDIUM STORING PROGRAM, INFORMATION PROCESSING APPARATUS, CONTROL METHOD OF INFORMATION PROCESSING APPARATUS, COMMUNICATION APPARATUS, AND COMMUNICATION SYSTEM

(71) Applicant: CANON KABUSHIKI KAISHA, Tokyo (JP)

(72) Inventors: HIROYOSHI IWAYAMA, Kanagawa (JP); NATSUMI KIKUTA, Tokyo (JP); KEISUKE MIZUTANI, Kanagawa (JP)

(21) Appl. No.: 19/263,611

(22) Filed: Jul. 9, 2025

(30) Foreign Application Priority Data
Jul. 16, 2024 (JP) 2024-113633

(51) Int. Cl. H04N 1/00; H04W 76/10

(52) U.S. Cl. CPC H04N 1/00244; H04W 76/10; H04N 2201/0094

(57) ABSTRACT

An information processing apparatus, including: an acquisition unit configured to, when it is impossible to execute wireless communication with a communication apparatus via an external access point (AP), acquire, from the information processing apparatus, first network information concerning wireless communication between the information processing apparatus and the external AP; a request unit configured to, when it is impossible to execute wireless communication with the communication apparatus via the external AP but wireless communication with an external server can be executed, request second network information concerning wireless communication between the communication apparatus and the external AP from the external server; and a notification unit configured to make a notification for executing wireless communication with the communication apparatus via the external AP based on at least one of the first network information and a response result to the request.

### BACKGROUND

### Field of the Technology

The present disclosure relates to a non-transitory computer-readable storage medium storing a program, an information processing apparatus, a control method of the information processing apparatus, a communication apparatus, and a communication system.

### Description of the Related Art

There is known a technique of transmitting, to a communication apparatus, information used to connect to an external apparatus such as a wireless LAN router, causing the communication apparatus to execute connection setting processing, and establishing wireless connection between the communication apparatus and an information processing apparatus via the external apparatus, thereby performing intercommunication. In this technique, establishment of wireless connection between the communication apparatus and the information processing apparatus via the external apparatus sometimes fails. Japanese Patent Laid-Open No. 2012-109790 discloses a technique in which, when a communication apparatus fails in establishing wireless connection to an external apparatus, to determine the cause, information about wireless connection of the communication apparatus is transmitted from the communication apparatus to an information processing apparatus via a communication path different from that of the wireless connection via the external apparatus.

### SUMMARY

The present disclosure provides a technique of improving user convenience if wireless communication via an external apparatus cannot be performed between apparatuses capable of wirelessly communicating via the external apparatus.

The present disclosure in one aspect provides a non-transitory computer-readable storage medium storing a program configured to cause a computer of an information processing apparatus capable of executing wireless communication using an external access point to function as: a first acquisition unit configured to, in a case where it is impossible to execute wireless communication with a communication apparatus via the external access point, acquire, from the information processing apparatus, first network information concerning wireless communication between the information processing apparatus and the external access point; a first request unit configured to, in a case where it is impossible to execute wireless communication with the communication apparatus via the external access point but wireless communication with an external server different from the external access point and the communication apparatus can be executed, request second network information concerning wireless communication between the communication apparatus and the external access point from the external server; and a notification unit configured to make a notification for executing wireless communication with the communication apparatus via the external access point based on at least one of the first network information and a response result to the request.

According to the present disclosure, it is possible to provide a technique of improving user convenience if wireless communication via an external apparatus cannot be performed between apparatuses capable of wirelessly communicating via the external apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing an example of the configuration of a communication system;

FIGS. 2A and 2B are flowcharts executed by a setup program;

FIG. 3 is a flowchart executed by the setup program;

FIGS. 4A to 4H are views each showing a dialogue displayed by the setup program; and

FIG. 5 is a view showing the hardware configurations of an information processing apparatus and a communication apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the conventional technique, if it is impossible to establish wireless connection between a communication apparatus and an information processing apparatus via an external apparatus, to acquire information about wireless connection of the communication apparatus, a communication path for enabling communication needs to be established between the information processing apparatus and the communication apparatus. However, in some cases, such a communication path cannot be established between the information processing apparatus and the communication apparatus. Also, even if the communication path can be established, it may take labor to establish the communication path. Hence, there is a demand for a technique of improving user convenience if wireless communication via an external apparatus cannot be performed between apparatuses capable of wirelessly communicating via the external apparatus.

According to one aspect of the present disclosure, it is possible to improve user convenience if wireless communication via an external apparatus cannot be performed between apparatuses capable of wirelessly communicating via the external apparatus.

### First Embodiment

### <System Configuration>

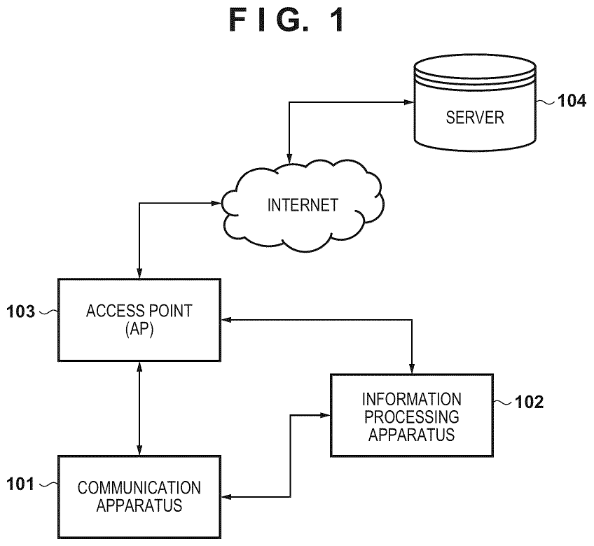

FIG. 1 is a view of an example of the configuration of a communication system according to this embodiment. In an example, this system is a wireless communication system in which a plurality of communication apparatuses can wirelessly communicate with each other. In the example shown in FIG. 1, the communication system includes a communication apparatus 101, an information processing apparatus 102, an access point 103, and a server 104. Note that the access point 103 is sometimes called the AP 103.

The communication apparatus 101 is, for example, a printing apparatus having a printing function, and may further have a reading function (scanner), a FAX function, and a telephone function. The communication apparatus 101 according to this embodiment has a communication function capable of wirelessly communicating with the information processing apparatus 102. A case where the a printing apparatus is used as an example of the communication apparatus 101 will be described in this embodiment, but the present disclosure is not limited to this. The communication apparatus 101 may be, for example, a scanner device, a projector, a mobile terminal, a smartphone, a notebook PC, a tablet terminal, Personal Digital Assistant (PDA), a digital camera, a music player, a television, or a smart speaker having a communication function.

The information processing apparatus 102 is an apparatus having a wireless communication function by a wireless LAN or the like. Note that the wireless LAN is sometimes referred to as WLAN hereinafter. In this embodiment, for example, a smartphone will be exemplified as the information processing apparatus 102. The smartphone is a multifunction mobile phone having not only a telephone function but also a camera function, an Internet browser function, a mail function, and the like. Note that the information processing apparatus 102 is not limited to the smartphone. For example, various apparatuses capable of installing a program, such as a personal information terminal such as a PDA, a tablet terminal, a digital camera, a personal computer, a music player, and a television can be applied as the information processing apparatus 102.

The access point 103 is an external apparatus (external access point) that exists outside the information processing apparatus 102 and outside the communication apparatus 101. Note that the access point will be referred to as an AP in the following explanation. More specifically, the AP 103 is, for example, a device such as a wireless LAN router. Note that the AP 103 is not limited to the wireless LAN router and may be an apparatus capable of relaying wireless communication.

The information processing apparatus 102 and the communication apparatus 101 can be connected to the AP 103. The information processing apparatus 102 can communicate with the communication apparatus 101 via the AP 103. A method of connecting the information processing apparatus 102 and the communication apparatus 101 via the AP 103 is generally called infrastructure connection. In infrastructure connection, a network environment in which a plurality of devices can communicate with each other can be constructed. Normally, the AP 103 is configured to be capable of Internet communication (cloud communication), and a device connected to the AP 103 can access the Internet via the AP 103. On the other hand, a method of directly connecting a terminal device and a communication apparatus only between the two devices (that is, without interposing the AP 103) is called direct connection. In this embodiment, infrastructure connection and direct connection between the information processing apparatus 102 and the communication apparatus 101 are connections by a communication method based on the standard of the IEEE 802.11 series. More specifically, the communication method based on the standard of the IEEE 802.11 series is Wireless Fidelity (Wi-Fi) R.

For example, upon receiving network information (to be described later) of the communication apparatus 101 from the communication apparatus 101 via the AP 103, the server 104 stores the network information of the communication apparatus 101. Also, for example, if the information processing apparatus 102 requests the network information of the communication apparatus 101, the server 104 returns the network information of the communication apparatus 101 in response to the request.

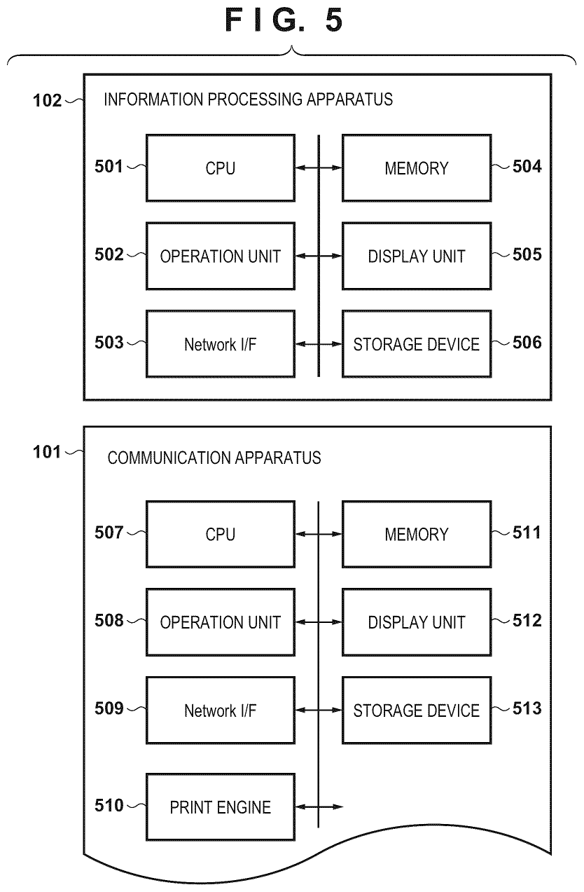

FIG. 5 is a view showing the hardware configurations of the information processing apparatus 102 and the communication apparatus 101 according to this embodiment. The information processing apparatus 102 includes a CPU 501, an operation unit 502, a network interface 503, a memory 504, a display unit 505, and a storage device 506, and these are connected via a system bus.

The CPU 501 is a system control unit including at least one processor, and controls the overall information processing apparatus 102. The operation unit 502 is an interface capable of accepting a user operation for the information processing apparatus 102 and includes, for example, buttons and a touch panel.

The memory 504 is a random access memory (RAM) serving as the work area of the CPU 501, and is used as a temporary storage area for various kinds of received data and stores various kinds of setting data. The storage device 506 is, for example, a flash memory and stores various kinds of control programs such as application programs and an operating system (to be referred to as an OS hereinafter). In this embodiment, a setup program to be described later is also stored in the storage device 506.

The network interface 503 is an interface used to connect to a network. The information processing apparatus 102 is configured to be connectable to a network via the network interface 503 and connectable to an external device or the Internet (cloud) via the network. For example, the network interface 503 is connected to the AP 103 having Internet connection, and the information processing apparatus 102 can be connected to an external device such as the communication apparatus 101 or the server 104 via the AP 103.

Like the information processing apparatus 102, the communication apparatus 101 includes a CPU 507, an operation unit 508, a network interface 509, a memory 511, a display unit 512, and a storage device 513, and these are connected via a system bus. The communication apparatus 101 also includes a print engine 510. The print engine 510 executes image forming processing of forming an image on a print medium by applying a printing material such as ink to the print medium such as paper based on information stored in the memory 511 or a print job received from the information processing apparatus 102 or the like, and outputs the print result. Note that the print job is a job for causing the communication apparatus 101 to execute image forming processing.

### <Direct Connection>

Direct connection is a form in which devices are wirelessly connected directly (that is, Peer to Peer) without interposing an external apparatus such as the AP 103. Direct connection is also called Peer to Peer connection (P2P connection). The communication apparatus 101 can operate in a mode (direct connection mode) for communicating by direct connection as one of connection modes. In Wi-Fi communication, there exist a plurality of modes for communicating by direct connection, like a software AP mode and a Wi-Fi Direct (WFD) mode.

A mode in which direct connection is executed by WFD is called a WFD mode. WFD is a standard formulated by the Wi-Fi Alliance and included in the communication standards of IEEE 802.11 series. In the WFD mode, a device that is a communication partner is searched for by a device search command, the roles of the group owner (GO) of P2P and the client of P2P are decided, and the rest of wireless connection processing is performed. The group owner corresponds to the master station (master device) of Wi-Fi, and the client corresponds to a slave station (slave device) of Wi-Fi. This role decision corresponds to, for example, GO Negotiation in P2P. Note that in the WFD mode before the role decision is performed, the communication apparatus 101 is neither a master station nor a slave station. More specifically, one of devices to perform communication issues a device search command and searches for a device to be connected in the WFD mode. If another device as a communication partner is discovered, both devices confirm information about services and functions that can be supplied between these. Note that the device supply information confirmation is optional and not essential. The device supply information conformation phase corresponds to, for example, Provision Discovery in P2P.

Next, each other's device supply information is confirmed to decide the roles, that is, which device should be the client of P2P and which should be the group owner of P2P. Next, when the client and the group owner are decided, parameters used to perform communication by WFD are exchanged between the devices. Based on the exchanged parameters, the rest of wireless connection processing and IP connection processing are performed between the client and the group owner of P2P. Note that in the WFD mode, the communication apparatus 101 may always operate as GO without executing the above-described GO Negotiation. That is, the communication apparatus 101 may operate in a WFD mode as an Autonomous GO mode. A state in which the communication apparatus 101 operates in the WFD mode is, for example, a state in which connection by WFD is not established, but the communication apparatus 101 operates as the GO or a state in which connection by WFD is established, and the communication apparatus 101 operates as the GO.

In the software AP mode, one (for example, the information processing apparatus 102) of devices to perform communication (for example, the information processing apparatus 102 and the communication apparatus 101) is the client that plays the role of requesting various kinds of services. The other device implements the function of an AP in Wi-Fi by software setting. The software AP corresponds to the master station of Wi-Fi, and the client corresponds to a slave station of Wi-Fi. In the software AP mode, the client searches for a device as a software AP by a device search command. If a software AP is discovered, the rest of wireless connection processing (establishment of wireless connection, and the like) is performed between the client and the software AP and, after that, IP connection processing (IP address assignment, and the like) is performed. Note that as the commands and parameters transmitted/received when implementing wireless connection between the client and the software AP, those defined in the Wi-Fi standard are used, and a description thereof will be omitted here.

In this embodiment, in a case where the communication apparatus 101 establishes/maintains direct connection, it operates as a master station in the network to which the communication apparatus 101 belongs. Note that the master station is a device that constructs a wireless network and provides, to a slave station, parameters used for connection to the wireless network. The parameters used for connection to the wireless network are, for example, parameters concerning a channel used by the master station. The slave station receives the parameters, thereby connecting, using the channel used by the master station, to the wireless network constructed by the master station. In the direct connection mode, since the communication apparatus 101 operates as the master station, the communication apparatus 101 can decide which frequency and channel should be used for communication in the direct connection mode. In this embodiment, the communication apparatus 101 can use a channel corresponding to a 2.4-GHz frequency band and a channel corresponding to a 5-GHz frequency band for communication in the direct connection mode.

### <Wi-Fi Communication (Infrastructure Connection Mode)>

To establish connection (infrastructure connection) by the connection form of the infrastructure method in Wi-Fi communication, the communication apparatus 101 according to this embodiment operates in the infrastructure connection mode. Note that in this embodiment, infrastructure connection indicates a form in which an external apparatus such as the AP 103 that controls the network operates as a master device, and apparatuses are wirelessly connected via the master device. The communication apparatus 101 that is operating in the infrastructure connection mode operates as a slave device in the network to which the communication apparatus 101 belongs. By the infrastructure connection mode, the communication apparatus 101 and the information processing apparatus 102 are connected via the AP 103, and communication apparatus 101 and the information processing apparatus 102 can communicate via the AP 103. Note that a channel used for communication in the infrastructure connection mode may be a frequency band (for example, 5.0 GHZ) other than 2.4 GHz. Note that to communicate with the communication apparatus 101 via the AP 103, the information processing apparatus 102 needs to recognize that the communication apparatus 101 belongs to the network which is formed by the AP 103 and to which the information processing apparatus 102 belongs. More specifically, the information processing apparatus 102 transmits a search signal, via the AP 103, to the network to which the information processing apparatus 102 belongs and performs a connectivity test with the communication apparatus 101. In this embodiment, a state in which the information processing apparatus 102 and the communication apparatus 101 are simply connected to the same AP is considered as an infrastructure connection state. That is, in the infrastructure connection state, the information processing apparatus 102 and the communication apparatus 101 need only be connected to the same AP and need not recognize that the partner apparatus belongs to the network to which the self-apparatus belongs.

### <Connection Setting Processing>

In this embodiment, the information processing apparatus 102 executes, using wireless communication with the communication apparatus 101, setting (connection setting) for causing the communication apparatus 101 to operate in the infrastructure connection mode. Connection setting processing according to this embodiment is executed by wireless communication and is therefore called cableless setup (CLS). Note that the connection setting processing may be executed by wired communication. The communication apparatus 101 executes connection setting processing in a state in which it is operating in a connection setting mode that is a mode for executing connection setting processing. Details of the connection setting mode will be described later. The information processing apparatus 102 performs connection setting processing when a predetermined program is activated. The predetermined program is an application program configured to not only set the connection destination AP of the communication apparatus 101 and but also cause the communication apparatus 101 to print image data or document data in the information processing apparatus 102, and will be referred to as a setup program hereinafter.

Note that the setup program may have functions other than the function of executing connection setting processing that is processing of setting the connection destination AP of the communication apparatus 101 and the function of causing the communication apparatus 101 to execute printing by transmitting a setting command to the communication apparatus 101. For example, the setup program may have a function of causing the communication apparatus 101 to scan a set original if the communication apparatus 101 has a scan function, a function of doing another setting of the communication apparatus 101, and a function of confirming the state (status) of the communication apparatus 101. The setup program has the function of executing connection setting processing but may not have other functions such as the function of causing the communication apparatus 101 to execute printing. Note that, more specifically, the function of causing the communication apparatus 101 to execute printing is a function of transmitting, to the communication apparatus 101, a print job for causing the communication apparatus 101 to execute printing. More specifically, the function of causing the communication apparatus 101 to scan a set original is a function of transmitting, to the communication apparatus 101, a scan job for causing the communication apparatus 101 to execute scan. More specifically, the function of confirming the state of the communication apparatus 101 is a function of acquiring, from the communication apparatus 101, information indicating the status of the communication apparatus 101 and displaying it. Also, the setup program is an application program.

Hereinafter, processing executed by the setup program is implemented in fact by reading out the setup program stored in the storage device 506 to the memory 504 by the CPU 501 and executing it. To connect the AP 103 and the communication apparatus 101 and cause the communication apparatus 101 to operate in the infrastructure connection mode, the information processing apparatus 102 wirelessly transmits, to the communication apparatus 101, an infrastructure setting command for causing the communication apparatus 101 to operate in the infrastructure connection mode. The infrastructure setting command includes, for example, information about the AP 103. Information about the AP 103 is, for example, information about the Service Set Identifier (SSID) of the AP 103, a password used to connect to the AP 103, and a frequency band used by the AP 103. After infrastructure connection by Wi-Fi is established between the information processing apparatus 102 and the communication apparatus 101 by connection setting processing, communication can be performed between the information processing apparatus 102 and the communication apparatus 101 via the established connection. More specifically, for example, the information processing apparatus 102 can transmit a print job for causing the communication apparatus 101 to execute printing or a scan job for causing the communication apparatus 101 to execute scan to the communication apparatus 101 via the established connection. Also, if infrastructure connection is established, the communication apparatus 101 can perform Internet communication via the AP 103. As an example, the communication apparatus can receive a device updating notification from a specific server, download print data, or upload information of the communication apparatus.

### <Upload of NW Information to Server>

The communication apparatus 101 is set such that it can communicate with the specific server 104 via the Internet if connection setting processing to the AP 103 succeeds. In this embodiment, if communication with the server 104 is possible, the communication apparatus 101 uploads the NW information (network information) of the communication apparatus 101 to the server 104, linking it with the specific information of the communication apparatus 101. More specifically, the specific information is the serial number of the communication apparatus 101 (a unique ID assigned to the communication apparatus 101). That is, the specific information is information for identifying the communication apparatus 101. Also, the NW information of the communication apparatus 101 is information used to connect to the AP 103, and examples are the Service Set Identifier (SSID) and password of the AP 103, an IP address assigned to the communication apparatus, and the radio field intensity (radio wave intensity) between devices connected to the AP 103.

The communication apparatus 101 transmits the NW information of the communication apparatus 101 to the server 104 in a single JavaScript Object Notation (JSON) format using the specific information (serial number) of the communication apparatus 101 as a key. The transmitted NW information of the communication apparatus 101 is saved in the server 104. The NW information of the communication apparatus 101 saved in the server 104 is transmitted from the server 104 to the information processing apparatus 102 via the Internet based on a request of the setup program stored in the information processing apparatus 102.

Here, if it is possible to access the Internet via the AP 103, the communication apparatus 101 may transmit the NW information of the communication apparatus 101 to the server 104 only once or periodically. For example, when the communication apparatus 101 periodically uploads the NW information of the communication apparatus 101 to the server 104, the NW information of the communication apparatus 101 saved in the server 104 is successively updated. Also, the communication apparatus 101 may display, on the display unit 512, a message indicating that the NW information of the communication apparatus 101 is to be uploaded to the server 104, and only upon accepting user's agreement, upload the NW information of the communication apparatus 101. In addition, the communication apparatus 101 may upload the NW information of the communication apparatus 101 to the server 104 in a case where it is impossible to establish communication with the information processing apparatus 102 via the AP 103.

The server 104 may delete the stored NW information of the communication apparatus 101 after the NW information of the communication apparatus 101 is transmitted to the information processing apparatus 102 in response to a request from the setup program, or may delete the NW information after the elapse of a predetermined period.

### <Connection Setting Mode>

As described above, the communication apparatus 101 can operate in the connection setting mode. As a trigger for the communication apparatus 101 to start the operation in the connection setting mode, for example, the user may press a connection setting mode button or the communication apparatus 101 may be activated (powered on) for the first time after arrival. The connection setting mode button may be a physical button provided on the communication apparatus 101 or a software button that the communication apparatus 101 displays on the display unit 512. When the operation in the connection setting mode is started, the communication apparatus 101 enables Wi-Fi communication. More specifically, as processing of enabling Wi-Fi communication, the communication apparatus 101 enables an AP (connection setting AP) in the communication apparatus 101, which is dedicated to the connection setting mode. The communication apparatus 101 is thus set in a state in which it can establish direct connection by Wi-Fi with the information processing apparatus 102. Connection information (an SSID and a password) used to connect to the connection setting AP is held in advance in the setup program installed in the information processing apparatus 102. The information processing apparatus 102 recognizes the connection information used to connect to the connection setting AP in advance. For this reason, unlike the connection information of the AP enabled in the direct connection mode, the connection information used to connect to the connection setting AP cannot arbitrarily be changed by the user. Note that in the connection setting mode, the communication apparatus 101 may be connected to the information processing apparatus 102 not by normal Wi-Fi but by WFD. That is, the communication apparatus 101 may operate as a Group Owner and receive the setting command from the information processing apparatus 102 by communication by WFD.

<Case where Communication Via AP Fails>

As described above, the communication apparatus 101 attempts establishing connection between the communication apparatus 101 and the AP 103 based on the connection information of the AP 103 received from the information processing apparatus 102. However, there is a case where it is impossible to perform communication between the communication apparatus 101 and the information processing apparatus 102 via the AP 103. In the following explanation, that communication cannot be performed between the communication apparatus 101 and the information processing apparatus 102 via the AP 103 will sometimes be referred to as a communication error. An example of a case where the communication error occurs will be described below.

In the above-described connection setting processing, for example, the setup program displays an input screen for the password (security key) of the AP 103 on the display unit 505 and accepts a user input of the password of the AP 103. The setup program then transmits information about the AP 103, including the password of the AP 103 whose input is accepted, from the information processing apparatus 102 to the communication apparatus 101. However, for example, if the user erroneously inputs the password of the AP 103, the information about the AP 103 the information processing apparatus 102 transmits to the communication apparatus 101 is wrong. In this case, even if connection to the AP 103 is attempted using the information about the AP 103 received from the information processing apparatus 102, the communication apparatus 101 fails in the connection. Hence, a communication error occurs.

Also, for example, an external apparatus existing around the communication apparatus 101 or the AP 103 may generate many noise radio waves. In this case, a communication error may occur. Additionally, for example, the communication apparatus 101 and the AP 103 may be far apart too much, or an object that blocks communication may exist between the communication apparatus 101 and the AP 103. In these cases, the radio field intensity in the communication between the communication apparatus 101 and the AP 103 is low, and a communication error may occur.

Also, for example, even if connection between the communication apparatus 101 and the AP 103 is successfully established, the information processing apparatus 102 and the AP 103 may be far apart too much, or an object that blocks communication may exist between the information processing apparatus 102 and the AP 103. In these cases, the radio field intensity in the communication between the information processing apparatus 102 and the AP 103 is low, and a communication error may occur.

Also, for example, the communication apparatus 101 and the information processing apparatus 102 may be connected to different APs. In this case, a communication error occurs. Furthermore, for example, a privacy separator function may be set in the AP 103. In this case, the AP 103 does not permit communication between devices connected to the same network. That is, even if connection between the communication apparatus 101 and the AP 103 is successfully established, a communication error occurs due to the setting of the privacy separator function in the AP 103.

Also, for example, connection between the communication apparatus 101 and the AP 103 is successfully established, but an apparatus existing around the information processing apparatus 102 or the AP 103 may generate many noise radio waves. In this case, a communication error occurs.

Also, for example, wireless communication between devices may be set disabled in security setting of the communication apparatus 101. In this case, the communication apparatus 101 cannot perform wireless communication with an apparatus such as the information processing apparatus 102, and a communication error occurs.

Various cases described above exist as cases where a communication error occurs even if the information processing apparatus 102 executes connection setting processing. The cause of the communication error exists in at least one of the information processing apparatus 102 and the communication apparatus 101 or in neither the information processing apparatus 102 nor the communication apparatus 101. That is, the cause of the communication error can be specified more appropriately by comprehensively conducting determination using not only the NW information of the information processing apparatus 102 but also the NW information of the communication apparatus 101.

<Download of NW Information from Server>

As described above, in some cases, even if the information processing apparatus 102 executes connection setting processing, it is impossible to execute communication between the information processing apparatus 102 and the communication apparatus 101 via the AP 103. In this case, the user should be notified of the cause of the communication error and promoted to eliminate it.

However, as described above, if the communication apparatus 101 attempts connecting to the AP 103, direct connection between the information processing apparatus 102 and the communication apparatus 101 is temporarily disconnected. For this reason, if communication with the communication apparatus 101 cannot be performed via the AP 103 after transmission of information about the AP 103, the information processing apparatus 102 cannot acquire, from the communication apparatus 101, the NW information of the communication apparatus 101 to specify the cause of the error. As a result, the information processing apparatus 102 cannot specify the cause of the communication error using the NW information of the communication apparatus 101. It is therefore impossible to notify the user whether the communication error has occurred because of the communication state between the communication apparatus 101 and the AP 103.

For this reason, for example, to acquire the NW information of the communication apparatus 101, the information processing apparatus 102 needs to communicate with the communication apparatus 101 via a communication path different from that of communication between the information processing apparatus 102 and the communication apparatus 101 via the AP 103. For example, the information processing apparatus 102 is assumed to be direct-connected to the communication apparatus 101 again. If the information processing apparatus 102 and the communication apparatus 101 each include a USB interface, the apparatuses are assumed to be connected by a USB cable. If the information processing apparatus 102 and the communication apparatus 101 each include a Bluetooth interface, the apparatuses are assumed to be connected by short distance wireless communication.

That is, if the information processing apparatus 102 should use the NW information of the communication apparatus 101 when specifying the cause of the communication error, a communication path different from the communication path via the AP 103 needs to be established between the information processing apparatus 102 and the communication apparatus 101. However, establishing another communication path takes labor. Also, the information processing apparatus 102 or the communication apparatus 101 may not include an interface for a predetermined communication path (for example, a direct connection interface, a USB interface, or a Bluetooth interface).

In this embodiment, if the information processing apparatus 102 cannot communicate with the communication apparatus 101 via the AP 103 but can communicate with the server 104, the NW information of the communication apparatus 101 is downloaded from the server 104 and used. By this form, the information processing apparatus 102 can acquire the NW information of the communication apparatus 101 without establishing the communication path different from the communication path between the information processing apparatus 102 and the communication apparatus 101 via the AP. The information processing apparatus 102 can then specify the cause of the failure of communication with the communication apparatus 101 via the AP 103 and make a notification to the user to enable communication with the communication apparatus 101 via the AP 103. Thus, even if the communication error occurs, the information processing apparatus 102 can perform determination to specify the cause of the error without making the user take labor. Also, for example, even if it is impossible to establish, between the information processing apparatus 102 and the communication apparatus 101, a communication path different from the communication path via the AP 103, the information processing apparatus 102 can acquire the NW information of the communication apparatus 101 and make a notification.

### <Determination Procedure>

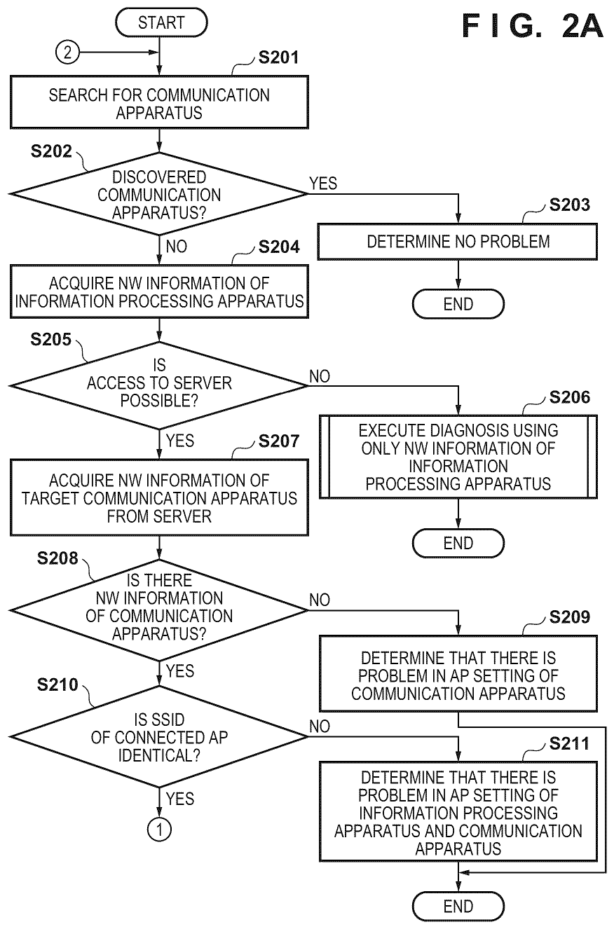

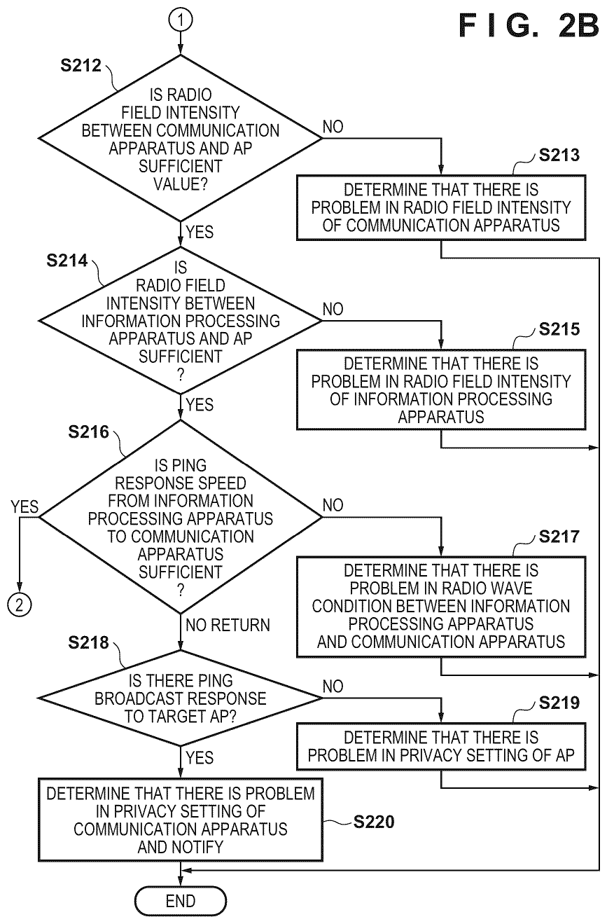

FIGS. 2A and 2B are flowcharts showing an example of processing of the setup program determining the cause of a failure of wireless communication between the information processing apparatus 102 and the communication apparatus 101 via the AP 103 and notifying the cause. This flowchart is implemented by reading out a program (more specifically, for example, the setup program) stored in the storage device 506 to the memory 504 by the CPU 501 and executing it. Also, this flowchart is started based on an operation performed, on a screen displayed by the setup program, to instruct communication with the communication apparatus. More specifically, the operation is, for example, an operation for transmitting a print job or a scan job to the communication apparatus. In addition, more specifically, the operation is, for example, an operation for acquiring, from the communication apparatus, the status of the communication apparatus. Also, this flowchart is started when, for example, the information processing apparatus 102 transmits a setting command to the communication apparatus 101 by connection setting processing and then switches the connection destination of its own from the communication apparatus 101 to the AP 103 connected before the connection setting processing.

In step S201, the setup program searches for the communication apparatus 101 that is the target of the above-described connection setting processing on the network formed by the AP 103 connected to the information processing apparatus 102. The search of the communication apparatus 101 is performed by transmitting a communication packet for the search to the AP 103 connected to the information processing apparatus 102 and acquiring a response from each communication apparatus connected to the AP 103.

In step S202, the setup program determines whether the communication apparatus 101 is discovered. Upon determining that the communication apparatus 101 is discovered, the setup program advances the process to step S203. On the other hand, upon determining that the communication apparatus 101 is not discovered, the setup program advances the process to step S204. More specifically, the setup program performs the determination based on whether a response from the desired communication apparatus 101 exists among the responses from a plurality of communication apparatuses acquired in step S201. The response from each of the plurality of communication apparatuses includes information for identifying the communication apparatus, such as an IP address, a MAC address, or a serial number for each communication apparatus. If the information of the desired communication apparatus 101 is included in the responses from the plurality of communication apparatuses, the setup program can find the communication apparatus 101. If the information of the desired communication apparatus 101 is not included, the setup program cannot find the communication apparatus 101. It can be said that in step S202, it is determined whether the information processing apparatus 102 can communicate with the communication apparatus 101 via the AP 103.

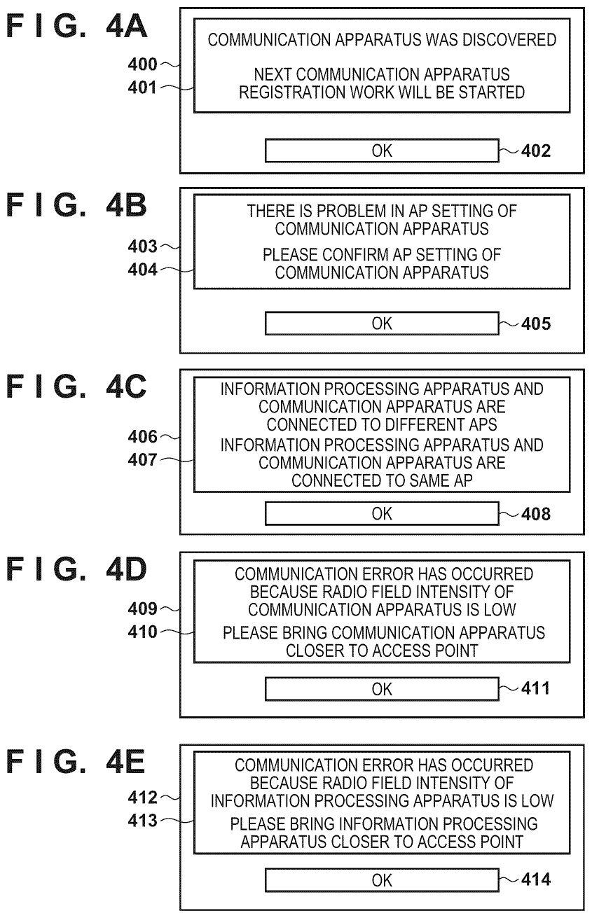

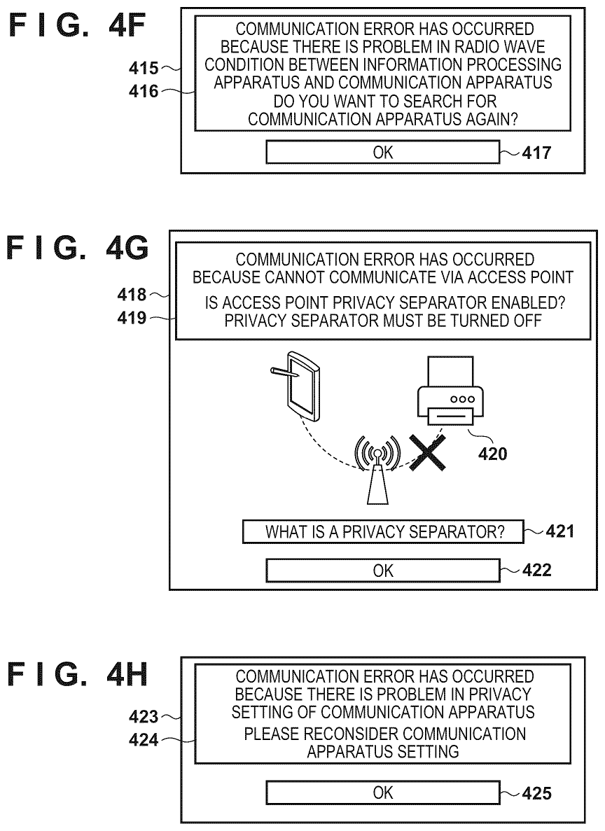

In step S203, the setup program notifies the user that the information processing apparatus 102 and the communication apparatus 101 are normally connected. This notification will be described later with reference to FIG. 4A. The setup program executes the processing of step S203 and then ends the processing shown in FIGS. 2A and 2B. After the end of the procedure, communication processing according to the operation or processing as the trigger for the flowchart is executed by the information processing apparatus 102. More specifically, for example, if the operation as the trigger for the flowchart is an operation for instructing communication with the communication apparatus 101, communication instructed by the operation is executed. More specifically, for example, transmission of a print job or transmission of a scan job and acquisition of information indicating the status of the communication apparatus 101 are executed. Also, for example, if the processing as the trigger for the flowchart is processing of switching the connection destination of the information processing apparatus 102 from the communication apparatus 101 to the AP 103 connected before the connection setting processing, acquisition of the capability information of the communication apparatus 101 is executed. Then, based on the acquired capability information, the communication apparatus 101 that is the target of the connection setting processing is registered in the setup program. When the communication apparatus 101 is registered in the setup program, transmission of a print job or transmission of a scan job can be executed for the communication apparatus 101 by the setup program from then on.

On the other hand, if communication with the communication apparatus 101 cannot be confirmed (NO in step S202), the setup program specifies, by the subsequent processing, the cause of the failure of communication between the information processing apparatus 102 and the communication apparatus 101 via the AP 103.

In step S204, the setup program acquires the NW information (network information) of the information processing apparatus 102. The NW information of the information processing apparatus 102 includes the SSID of the AP 103 connected to the information processing apparatus 102 and a value indicating the radio field intensity of the information processing apparatus 102. As for the NW information of the information processing apparatus 102, the setup program is configured to be able to acquire the latest information anytime by inquiring of the OS of the information processing apparatus 102. The setup program stores the acquired NW information of the information processing apparatus 102 in the memory 504 of the information processing apparatus 102.

In step S205, to acquire the NW information of the communication apparatus 101 saved in the server 104, the setup program determines whether access to the server 104 is possible. Upon determining that access is possible, the setup program advances the process to step S207. On the other hand, upon determining that access is impossible, the setup program advances the process to step S206. The setup program may determine whether access to the server 104 is possible using a PING response to the server 104. Alternatively, the setup program may perform the determination by inquiring of the OS whether cellular communication or Wi-Fi communication of the information processing apparatus 102 can be used.

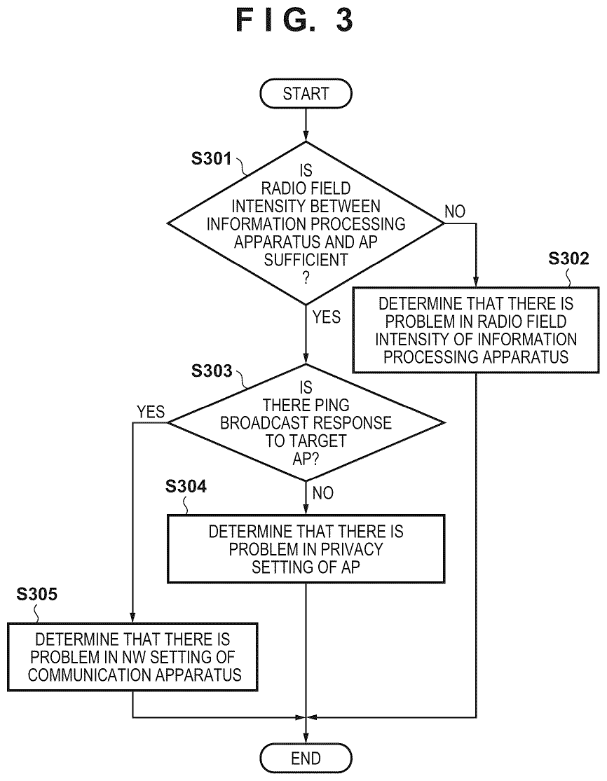

In step S206, using only the NW information of the information processing apparatus 102 acquired in step S204, the setup program determines the cause of the execution failure of wireless communication between the information processing apparatus 102 and the communication apparatus 101 via the AP 103. The processing of step S206 will be described later with reference to FIG. 3.

In step S207, the setup program designates the specific information of the communication apparatus 101 that is the target and requests the NW information of the communication apparatus 101 from the server 104. In this embodiment, the NW information of the communication apparatus 101 is saved in the server 104 using the serial number of the communication apparatus 101 as a key, as described above. When the serial number of the communication apparatus 101 is transmitted to the server 104, desired NW information is included in the response information of the communication.

In step S208, the setup program determines whether the NW information of the communication apparatus 101 is included in the response result of the server 104. Upon determining that the NW information is included, the setup program advances the process to step S210. On the other hand, upon determining that the NW information is not included, the setup program advances the process to step S209. More specifically, in a case where the NW information of the communication apparatus 101 is not saved in the server 104, even if the setup program requests it from the server 104 in step S207, response information that is the response result to the request is empty. For this reason, if the setup program cannot acquire the desired NW information from the server 104, it can be considered that the communication apparatus 101 cannot access the server 104 via the AP 103. That is, if the setup program cannot acquire the desired NW information from the server 104, it is possible to determine that the above-described connection setting processing fails and, therefore, the process advances to step S209. On the other hand, if the desired NW information can be acquired from the server 104, it is possible to determine that the connection setting processing succeeds and, therefore, the process advances to step S210.

In step S209, the setup program determines that the AP setting of the communication apparatus 101 has a problem and the communication apparatus 101 cannot perform wireless communication via the AP 103, and notifies the user of it. The notification in step S209 will be described later with reference to FIG. 4B.

In step S210, the setup program determines whether the SSID of the AP connected to the information processing apparatus 102 and the SSID of the AP connected to the communication apparatus 101 are identical. Upon determining that the SSIDs are identical, the setup program advances the process to step S212. On the other hand, upon determining that the SSIDs are different, the setup program advances the process to step S211. More specifically, the setup program acquires the information of the SSID of the AP connected to the communication apparatus 101, which is included in the NW information of the communication apparatus 101 acquired from the external server 104 in step S207. In addition, the setup program acquires the SSID of the AP connected to the information processing apparatus 102, which is included in the NW information of the information processing apparatus 102 acquired in step S204. The setup program then compares the SSIDs. It can be said that the SSID is identification information for identifying the network connected to each apparatus. If the SSIDs are different, it is possible to determine that the information processing apparatus 102 and the communication apparatus 101 are connected to different networks, and the process advances to step S211. On the other hand, if the SSIDs are identical, it is possible to determine that the information processing apparatus 102 and the communication apparatus 101 are connected to the same network, and the process advances to step S212. That is, it is possible to specify that the cause of the communication error exists in the information processing apparatus 102 and the communication apparatus 101 by determining the network connected to each apparatus in step S210.

In step S211, the setup program determines that the cause of the communication error is that the information processing apparatus 102 and the communication apparatus 101 are connected to different networks, and notifies the user of it. The notification in step S211 will be described later with reference to FIG. 4C.

In step S212, the setup program determines, based on the NW information of the communication apparatus 101, whether the radio field intensity between the communication apparatus 101 and the AP 103 is higher than a predetermined value. Upon determining that the radio field intensity is higher than the predetermined value, the setup program advances the process to step S214. On the other hand, upon determining that the radio field intensity is lower than the predetermined value, the setup program advances the process to step S213. For example, the radio field intensity is acquired as a value in five steps from 1 to 5. If the value is, for example, 3 or more, the setup program determines that the intensity is sufficient. In this case, since it is possible to determine that the radio field intensity between the communication apparatus 101 and the AP 103 is not the cause of the communication error, the setup program advances the process to step S214. On the other hand, if the value of the radio field intensity is, for example, 2 or less, the setup program determines that the intensity is not sufficient. In this case, since it is possible to determine that the radio field intensity between the communication apparatus 101 and the AP 103 is the cause of the communication error, the setup program advances the process to step S213.

In step S213, the setup program determines that the cause of the communication error is that the radio field intensity between the communication apparatus 101 and the AP 103 is low, and notifies the user of it. The notification in step S213 will be described later with reference to FIG. 4D.

In step S214, the setup program determines, based on the NW information of the information processing apparatus 102, whether the radio field intensity between the information processing apparatus 102 and the AP 103 is higher than a predetermined value. Upon determining that the radio field intensity is higher than the predetermined value, since it is possible to determine that the radio field intensity between the information processing apparatus 102 and the AP 103 is not the cause of the communication error, the setup program advances the process to step S216. On the other hand, upon determining that the radio field intensity is lower than the predetermined value, since it is possible to determine that the radio field intensity between the information processing apparatus 102 and the AP 103 is the cause of the communication error, the setup program advances the process to step S215. Note that determining whether the radio field intensity is higher than the predetermined value in step S214 is the same as that described concerning step S212, and a description thereof will be omitted.

In step S215, the setup program determines that the cause of the communication error is that the radio field intensity between the information processing apparatus 102 and the AP 103 is low, and notifies the user of it. The notification in step S215 will be described later with reference to FIG. 4E.

In step S216, the setup program confirms the Packet Internet Groper (PING) response to the IP address included in the NW information of the communication apparatus 101. For example, the setup program transmits a packet to a destination designated by the IP address included in the NW information of the communication apparatus 101 by executing a PING command, and determines whether a response to the transmission of the packet is received. The setup program then determines whether a PING response exists. Upon determining that no PING response exists, the setup program advances the process to step S218.

Upon determining in step S216 that a PING response is received from the communication apparatus 101, the setup program further determines whether the response time is shorter than a predetermined time. Upon determining that the response time is shorter than the predetermined time, the setup program returns the process to step S201 and executes a search for a communication apparatus. That is, wireless communication with the communication apparatus 101 is executed again via the AP 103. This is because that the time of the PING response from the communication apparatus 101 is short in step S216 indicates that the communication apparatus 101 is discovered by the search via the AP 103. As an example, such a state may occur when the communication apparatus 101 cannot be discovered by the above-described search in step S201 because of a temporary reason such as a sudden radio wave failure or the communication apparatus 101 that is in a busy state and cannot return a response. On the other hand, upon determining that the response time is longer than the predetermined time, the setup program advances the process to step S217. For example, the setup program may execute the PING response a predetermined number of times (for example, five times), and if the average response time is 100 ms or more, determine that the response time is longer than the predetermined time. In this case, since it is possible to determine that the cause of the communication error is that the radio wave condition between the information processing apparatus 102 and the communication apparatus 101, that is, in the AP 103 is poor, the process advances to step S217. Thus, in step S216, the setup program performs communication confirmation for the communication apparatus 101 via the AP 103. The setup program then determines the cause of the communication error based on the communication confirmation. Note that it can be said that the above-described response time is a confirmation time when the setup program performs communication confirmation for the communication apparatus 101 via the AP 103.

In step S217, the setup program determines that the radio wave condition between the information processing apparatus 102 and the communication apparatus 101 has a problem, and notifies the user of it. The notification in step S217 will be described later with reference to FIG. 4F.

In step S218, the setup program confirms a PING response by broadcast for the connected AP 103. That is, the setup program performs communication confirmation by broadcast for an external apparatus wirelessly connected to the AP 103. For example, the setup program executes a PING command, transmits a packet by broadcast to all external apparatuses belonging to the network formed by the AP 103, and determines whether a response to the transmission of the packet is received. The setup program then determines whether a PING response exists. Upon determining that a PING response exists, the setup program advances the process to step S220. On the other hand, upon determining that no PING response exists, the setup program advances the process to step S219. Here, for example, in some cases, not only the information processing apparatus 102 and the communication apparatus 101 but also another network device is connected to the AP 103. If it is determined in step S216 that a PING response from the communication apparatus 101 cannot be confirmed but a PING response from another network device is received, it is possible to determine that the privacy setting of the communication apparatus 101 has a problem. On the other hand, if there is no response to broadcast PING, it is possible to determine that the network separator function of the AP 103 is set enabled and communication between devices connected to the AP 103 is restricted.

In step S219, the setup program determines that the cause of the communication error is that the network separator function of the AP 103 is enabled, and notifies the user of it. The notification in step S219 will be described later with reference to FIG. 4G.

Thus, in step S219, if there is no response from the external apparatuses wirelessly connected to the AP 103, including the communication apparatus 101, as the result of communication confirmation in step S216 and communication confirmation in step S218, the setup program determines the privacy setting (network separator function) of the AP 103 as the cause. By this determination, it can be specified that the cause of the communication error is in the AP 103. Also, upon determining the privacy setting of the AP 103 as the cause of the communication error, the setup program makes a notification indicating that the privacy setting of the AP 103 has a problem. This makes it possible to represent the cause of the communication error to the user.

In step S220, the setup program determines that the cause of the communication error is that communication is restricted by the privacy setting of the communication apparatus 101, or the like, and notifies the user of it. The notification in step S220 will be described later with reference to FIG. 4H.

Thus, in step S220, if there is no response only from the communication apparatus 101 as the result of communication confirmation in step S216 and communication confirmation in step S218, the setup program determines the privacy setting of the communication apparatus 101 as the cause. By this determination, it can be specified that the cause of the communication error is in the communication apparatus 101. Also, upon determining the privacy setting of the communication apparatus 101 as the cause of the communication error, the setup program makes a notification indicating that the privacy setting of the communication apparatus 101 has a problem. This makes it possible to represent the cause of the communication error to the user.

As described above, the setup program can specifically determine the cause of the communication error using the NW information of the information processing apparatus 102 uploaded to the cloud, and notify the user of it.

<Determination in Case where NW Information of Communication Apparatus 101 Cannot be Acquired>

Processing of determining, by the setup program, the cause of the communication error using only the NW information of the information processing apparatus 102 in step S206 will be described. Even if connection setting processing between the communication apparatus 101 and the AP 103 succeeds, the AP 103 may not be connected to the Internet. In this case, in step S205, the setup program determines that it is impossible to execute wireless communication with the server 104 (it is impossible to access the server 104). That is, the setup program cannot acquire the NW information of the communication apparatus 101 from the server 104. In step S206, the setup program determines the cause of the communication error using only the NW information of the information processing apparatus 102, which is acquired from the information processing apparatus 102 in step S204. FIG. 3 shows the flowchart of processing executed in step S206. Processing shown in FIG. 3 is implemented by reading out a program (more specifically, for example, the setup program) stored in the storage device 506 to the memory 504 by the CPU 501 and executing it.

In step S301, it is determined, based on the NW information of the information processing apparatus 102, whether the radio field intensity between the information processing apparatus 102 and the AP 103 is higher than a predetermined value. Upon determining that the radio field intensity is higher than the predetermined value, since it is possible to determine that the radio field intensity between the information processing apparatus 102 and the AP 103 is not the cause of the communication error, the setup program advances the process to step S303. On the other hand, upon determining that the radio field intensity is lower than the predetermined value, since it is possible to determine that the radio field intensity between the information processing apparatus 102 and the AP 103 is the cause of the communication error, the setup program advances the process to step S302. Note that determining whether the radio field intensity is higher than the predetermined value in step S301 is the same as that described concerning step S212, and a description thereof will be omitted.

In step S302, the setup program determines that the cause of the communication error is that the radio field intensity between the information processing apparatus 102 and the AP 103 is low, and notifies the user of it. The notification in step S302 will be described later with reference to FIG. 4E.

In step S303, the setup program confirms a PING response by broadcast for the connected AP 103. The setup program determines whether a PING response exists. The setup program determines whether a PING response exists, and upon determining that a PING response exists, the setup program advances the process to step S305. On the other hand, upon determining that no PING response exists, the setup program advances the process to step S304. The processing of step S303 is the same as step S218, and a description thereof will be omitted.

In step S304, the setup program determines that the cause of the communication error is that the network separator function of the AP 103 is enabled, and notifies the user of it. The notification in step S304 will be described later with reference to FIG. 4G.

In step S305, the setup program determines that the cause of the communication error is that communication is limited by the privacy setting of the communication apparatus 101, or the like, and notifies the user of it. The notification in step S305 will be described later with reference to FIG. 4H.

As described above, even if the NW information of the communication apparatus 101 cannot be acquired from the server 104, the setup program attempts specifying the cause of the communication error using only the NW information of the information processing apparatus 102. The setup program notifies the user of the result.

### <User Notification of Determination Result>

Notification examples in the processing shown in FIGS. 2 and 3 will be described next with reference to FIGS. 4A to 4H. In the processing shown in FIGS. 2 and 3, the setup program makes notifications to the user in dialogue forms shown in FIGS. 4A to 4H on the display unit 505.

FIG. 4A shows a notification example in a case where the setup program determines in step S203 that communication between the information processing apparatus 102 and the communication apparatus 101 has no problem. In step S203, the setup program displays a dialogue 400 on the display unit 505. A notification portion 401 and an OK button 402 are displayed in the dialogue 400. The notification portion 401 displays a message indicating that the communication apparatus 101 is discovered and processing can normally be continued, and a message indicating that communication processing according to the operation or processing as the trigger for the flowchart is to be started. The OK button 402 is an interface capable of accepting an instruction for starting communication processing according to the operation or processing as the trigger for the flowchart.

FIG. 4B shows a notification example in a case where the setup program determines in step S209 that the cause of the communication error is that the AP setting of the communication apparatus 101 has a problem. In step S209, the setup program displays a dialogue 403 on the display unit 505. A notification portion 404 and an OK button 405 are displayed in the dialogue 403. The notification portion 404 shows a message indicating that the AP setting of the communication apparatus 101 has a problem. That is, it can be said that the dialogue 403 is a notification indicating that the cause of the communication error is in the communication apparatus 101. In addition, the notification portion 404 displays a message indicating that the user is promoted to confirm the AP setting of the communication apparatus 101. The OK button 405 is an interface capable of accepting an execution instruction for executing the processing shown in FIGS. 2A and 2B again.

FIG. 4C shows a notification example in a case where the setup program determines in step S211 that the cause of the communication error is that the information processing apparatus 102 and the communication apparatus 101 are connected to different APs. In step S211, the setup program displays a dialogue 406 on the display unit 505. A notification portion 407 and an OK button 408 are displayed in the dialogue 406. The notification portion 407 displays a message indicating that the information processing apparatus 102 and the communication apparatus 101 are connected to different APs. That is, it can be said that the dialogue 406 is a notification indicating that the cause of the communication error is in the information processing apparatus 102 and the communication apparatus 101. In addition, the notification portion 407 displays a message indicating that the user is promoted to connect the information processing apparatus 102 and the communication apparatus 101 to the same AP. The OK button 408 is an interface capable of accepting an execution instruction for executing the processing shown in FIGS. 2A and 2B again.

FIG. 4D shows a notification example in a case where the setup program determines in step S213 that the cause of the communication error is that the radio field intensity between the communication apparatus 101 and the AP 103 is low. In step S213, the setup program displays a dialogue 409 on the display unit 505. A notification portion 410 and an OK button 411 are displayed in the dialogue 409. The notification portion 410 displays a message indicating that the communication error has occurred because the radio field intensity between the communication apparatus 101 and the AP 103 is low. That is, it can be said that the dialogue 409 is a notification indicating that the cause of the communication error is in the communication apparatus 101. In addition, the notification portion 410 displays a message indicating that the user is promoted to bring the communication apparatus 101 closer to the AP 103. Note that the notification portion 410 may display a message indicating that, for example, the user is promoted to confirm whether a blocking object that blocks a radio wave exists between the communication apparatus 101 and the AP 103. Also, the notification portion 410 may display a message indicating that, for example, the user is promoted to confirm whether a device that generates a noise radio wave exists between the communication apparatus 101 and the AP 103. It is considered that, for example, if the user brings the communication apparatus 101 closer to the AP 103 by this notification, the problem that the radio field intensity of the communication apparatus 101 is low as the cause of the current communication error is solved. The OK button 411 is an interface capable of accepting an execution instruction for executing the processing shown in FIGS. 2A and 2B again.

FIG. 4E shows a notification example in a case where the setup program determines in steps S215 and S302 that the cause of the communication error is that the radio field intensity between the information processing apparatus 102 and the AP 103 is low. In steps S215 and S302, the setup program displays a dialogue 412 on the display unit 505. A notification portion 413 and an OK button 414 are displayed in the dialogue 412. The notification portion 413 displays a message indicating that the communication error has occurred because the radio field intensity between the information processing apparatus 102 and the AP 103 is low. That is, it can be said that the dialogue 412 is a notification indicating that the cause of the communication error is in the information processing apparatus 102. In addition, the notification portion 413 displays a message indicating that the user is promoted to bring the information processing apparatus 102 closer to the AP 103. Note that the notification portion 413 may display a message indicating that, for example, the user is promoted to confirm whether a blocking object that blocks a radio wave exists between the information processing apparatus 102 and the AP 103. Also, the notification portion 413 may display a message indicating that, for example, the user is promoted to confirm whether a device that generates a noise radio wave exists between the information processing apparatus 102 and the AP 103. It is considered that, for example, if the user brings the information processing apparatus 102 closer to the AP 103 by this notification, the problem that the radio field intensity of the information processing apparatus 102 is low as the cause of the current communication error is solved. The OK button 414 is an interface capable of accepting an execution instruction for executing the processing shown in FIGS. 2A and 2B again.

FIG. 4F shows a notification example in a case where the setup program determines in step S217 that the cause of the communication error is that the radio wave condition between the information processing apparatus 102 and the communication apparatus 101 has a problem. In step S217, the setup program displays a dialogue 415 on the display unit 505. A notification portion 416 and an OK button 417 are displayed in the dialogue 415. The notification portion 416 displays a message indicating that the cause of the communication error is that the radio wave condition between the information processing apparatus 102 and the communication apparatus 101 has a problem, and a message that promotes to execute the search of the communication apparatus 101 again. Note that the notification portion 416 may display a message indicating that there is possibility that the AP 103 has a congested radio wave condition, or may display a message indicating that there is possibility that a sudden radio wave failure has occurred. In addition, the notification portion 416 may display a message indicating that there is possibility that the communication apparatus 101 is in a busy state. That is, it can be said that the dialogue 415 is a notification indicating that the cause of the communication error is in the communication apparatus 101 or the AP 103. In addition, the notification portion 416 may display a message that promotes to execute the search of the communication apparatus 101 again after the elapse of a predetermined time. The OK button 417 is an interface capable of accepting an execution instruction for executing the processing shown in FIGS. 2A and 2B again.

FIG. 4G shows a notification example in a case where the setup program determines in steps S219 and S304 that the cause of the communication error may be that the network separator function of the AP 103 is enabled. In steps S219 and S304, the setup program displays a dialogue 418 on the display unit 505. A notification portion 419, an icon 420, a detailed explanation button 421, and an OK button 422 are displayed in the dialogue 418. The notification portion 419 displays a message indicating that the communication error has occurred because the information processing apparatus 102 cannot communicate with the communication apparatus 101 via the AP 103. Also, the notification portion 419 displays a message indicating that there is possibility that the setting of the privacy separator function of the AP 103 is enabled, and a message indicating that if the setting of the privacy separator function is enabled, it needs to be set disabled. That is, it can be said that the dialogue 418 is a notification indicating that the cause of the communication error is not in either the information processing apparatus 102 or the communication apparatus 101 but in the AP 103.

The icon 420 indicates a state in which a communication error occurs. The icon 420 indicates, for example, the association between the information processing apparatus 102, the communication apparatus 101, and the AP 103 as a view showing the state. The icon 420 is thus displayed together with the messages in the notification portion 419, thereby visually notifying the user of the cause of the communication error. Note that the icon may be displayed in, for example, the dialogues shown in FIGS. 4B to 4F and 4H.

The detailed explanation button 421 is an interface capable of accepting a display instruction for displaying the cause of the communication error determined in steps S219 and S304 in more detail. Upon accepting the display instruction, the setup program displays, on the display unit 505, a help screen (not shown) configured to display the cause of the communication error in more detail. In this example, the help screen is a screen that displays a detailed description of the privacy separator function of the AP 103. The help screen is, for example, a web page. Note that, for example, upon accepting a display instruction, the setup program may activate a web browser provided in the information processing apparatus 102. Then, a web page that is the help screen may be displayed by the web browser. If display of the help screen can be accepted independently of the dialogue 418, even if the display region of the dialogue 418 is limited, a detailed description of the cause of the communication error can separately be displayed. Also, the OK button 422 is an interface capable of accepting an execution instruction for executing the processing shown in FIGS. 2A and 2B again.

FIG. 4H shows a notification example in a case where the setup program determines in steps S220 and S305 that communication is limited due to privacy setting of the communication apparatus 101 or the like. In steps S220 and S305, the setup program displays a dialogue 423 on the display unit 505. A notification portion 424 and an OK button 425 are displayed in the dialogue 423. The notification portion 424 displays a message indicating that the communication error has occurred because the privacy setting of the communication apparatus 101 has a problem, and a message indicating that the user is promoted to reconsider the privacy setting of the communication apparatus 101. That is, it can be said that the dialogue 423 is a notification indicating that the cause of the communication error is in the communication apparatus 101. Also, the OK button 425 is an interface capable of accepting an execution instruction for executing the processing shown in FIGS. 2A and 2B again.

As described above, according to this embodiment, the setup program acquires the NW information of the information processing apparatus 102 if the information processing apparatus 102 cannot execute wireless communication with the communication apparatus 101 via the AP 103. If wireless communication with the server 104 can be executed, the setup program requests the NW information of the communication apparatus 101 from the server 104. The setup program makes a notification for executing wireless communication with the communication apparatus 101 via the AP 103 based on at least one of the NW information of the information processing apparatus 102 and the response result to the request. With this form, even if a communication error occurs, a communication path different from the communication path via the AP 103 need not be established between the information processing apparatus 102 and the communication apparatus 101, and a notification to the user can be made. That is, it is possible to improve user convenience in a case of an error.

### Other Embodiments

In the first embodiment, a form in which the program that executes processing of the present disclosure is a setup program has been described. However, the present disclosure is not limited to this form. The program that executes processing of the present disclosure need only be a program configured to communicate with the communication apparatus 101, and may be, for example, a print program that does not have a function for executing connection setting processing but has a function for causing the communication apparatus 101 to execute printing. Alternatively, it may be a program having another function different from the function for causing the communication apparatus 101 to execute printing.

Also, in the first embodiment, in step S210, the setup program determines whether the SSID of the AP connected to the information processing apparatus 102 is the same as the SSID of the AP connected to the communication apparatus 101. It is thus confirmed whether the information processing apparatus 102 and the communication apparatus 101 are connected to the same AP. However, the present disclosure is not limited to this. In step S210, for example, the setup program may compare the global IP address of the information processing apparatus 102 and the global IP address of the communication apparatus 101 and determine whether these are identical. The network part of each IP address is assigned by a device that forms the network. Hence, it may be confirmed whether the information processing apparatus 102 and the communication apparatus 101 are connected to the same AP by comparing the IP address of the information processing apparatus 102 and the IP address of the communication apparatus 101.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-113633, filed Jul. 16, 2024 which is hereby incorporated by reference herein in its entirety.

What is claimed is:

1. A non-transitory computer-readable storage medium storing a program configured to cause a computer of an information processing apparatus capable of executing wireless communication using an external access point to function as:
a first acquisition unit configured to, in a case where it is impossible to execute wireless communication with a communication apparatus via the external access point, acquire, from the information processing apparatus, first network information concerning wireless communication between the information processing apparatus and the external access point;
a first request unit configured to, in a case where it is impossible to execute wireless communication with the communication apparatus via the external access point but wireless communication with an external server different from the external access point and the communication apparatus can be executed, request second network information concerning wireless communication between the communication apparatus and the external access point from the external server; and
a notification unit configured to make a notification for executing wireless communication with the communication apparatus via the external access point based on at least one of the first network information and a response result to the request.

2. The medium according to claim 1, wherein
the second network information is information linked with specific information of the communication apparatus, and
the first request unit designates the specific information and requests the second network information.

3. The medium according to claim 1, wherein
the notification indicates that a cause of a failure of execution of wireless communication with the communication apparatus via the external access point is in the communication apparatus, in the information processing apparatus, in the communication apparatus and the information processing apparatus, or in neither the communication apparatus nor the information processing apparatus.

4. The medium according to claim 1, wherein
the computer is further caused to function as a determination unit configured to determine a cause of a failure of execution of wireless communication with the communication apparatus via the external access point based on at least one of the first network information and the response result.

5. The medium according to claim 4, wherein
in a case where it is impossible to execute wireless communication with the external server, the determination unit determines the cause using only the first network information.

6. The medium according to claim 4, wherein
the computer is further caused to function as a first communication confirmation unit configured to perform first communication confirmation with the communication apparatus via the external access point, and
the determination unit determines the cause based on at least one of the first network information and the response result and then further determines the cause based on the first communication confirmation.

7. The medium according to claim 6, wherein
in a case where it is determined that a confirmation time in the first communication confirmation is longer than a predetermined time, the notification indicates that a radio wave condition between the information processing apparatus and the communication apparatus has a problem.

8. The medium according to claim 6, wherein
the computer is further caused to function as an execution unit configured to execute wireless communication with the communication apparatus via the external access point in a case where it is determined that a confirmation time in the first communication confirmation is shorter than a predetermined time.

9. The medium according to claim 6, wherein
the computer is further caused to function as a second communication confirmation unit configured to perform second communication confirmation by broadcast for an external apparatus wirelessly connected to the external access point,
in a case where no response is received only from the communication apparatus as a result of the first communication confirmation and the second communication confirmation, the determination unit determines a privacy setting of the communication apparatus as the cause, and
in a case where no response is received from wirelessly connected apparatuses including the communication apparatus as the result of the first communication confirmation and the second communication confirmation, the determination unit determines a privacy setting of the external access point as the cause.

10. The medium according to claim 9, wherein
in a case where the privacy setting of the communication apparatus is determined as the cause, the notification indicates that the privacy setting of the communication apparatus has a problem, and
in a case where the privacy setting of the external access point is determined as the cause, the notification indicates that the privacy setting of the external access point has a problem.

11. The medium according to claim 1, wherein
in a case where the second network information is not included in the response result, the notification notifies that the communication apparatus cannot perform wireless communication via the external access point.

12. The medium according to claim 1, wherein
the first network information includes first identification information for identifying a network to which the information processing apparatus is connected,
the second network information includes second identification information for identifying a network to which the communication apparatus is connected, and
in a case where the second network information is included in the response result and the first identification information and the second identification information are different, the notification indicates that the information processing apparatus and the communication apparatus are connected to different networks.

13. The medium according to claim 1, wherein
the second network information includes a value indicating a first radio field intensity (radio wave intensity) between the communication apparatus and the external access point, and
in a case where the second network information is included in the response result and the value indicating the first radio field intensity is lower than a predetermined value, the notification indicates that the first radio field intensity has a problem.

14. The medium according to claim 1, wherein
the first network information includes a value indicating a second radio field intensity between the information processing apparatus and the external access point, and
in a case where the value indicating the second radio field intensity is lower than a predetermined value, the notification indicates that the second radio field intensity has a problem.

15. The medium according to claim 1, wherein
the communication apparatus is a printing apparatus.

16. An information processing apparatus capable of executing wireless communication using an external access point, comprising:
at least one memory and at least one processor which function as:
a first acquisition unit configured to, in a case where it is impossible to execute wireless communication with a communication apparatus via the external access point, acquire, from the information processing apparatus, first network information concerning wireless communication between the information processing apparatus and the external access point;
a first request unit configured to, in a case where it is impossible to execute wireless communication with the communication apparatus via the external access point but wireless communication with an external server different from the external access point and the communication apparatus can be executed, request second network information concerning wireless communication between the communication apparatus and the external access point from the external server; and
a notification unit configured to make a notification for executing wireless communication with the communication apparatus via the external access point based on at least one of the first network information and a response result to the request.

17. A control method of an information processing apparatus capable of executing wireless communication using an external access point, comprising:
in a case where it is impossible to execute wireless communication with a communication apparatus via the external access point, acquiring, from the information processing apparatus, first network information concerning wireless communication between the information processing apparatus and the external access point;
in a case where it is impossible to execute wireless communication with the communication apparatus via the external access point but wireless communication with an external server different from the external access point and the communication apparatus can be executed, requesting second network information concerning wireless communication between the communication apparatus and the external access point from the external server; and
making a notification for executing wireless communication with the communication apparatus via the external access point based on at least one of the first network information and a response result to the request.

18. A communication apparatus capable of executing wireless communication using an external access point, comprising:
at least one memory and at least one processor which function as:
a transmission unit configured to, in a case where it is possible to execute wireless communication with an external server different from the external access point and the communication apparatus, transmit second network information concerning wireless communication between the communication apparatus and the external access point to the external server; and
the second network information is information that the information processing apparatus requests from the external server in a case where it is impossible to execute wireless communication between the communication apparatus and the information processing apparatus via the external access point but the information processing apparatus can execute wireless communication with the external server.

19. A communication system including a communication apparatus and an information processing apparatus,
wherein the communication apparatus comprises:
at least one memory and at least one processor which function as:
a transmission unit configured to, in a case where it is possible to execute wireless communication with an external server different from an external access point and the communication apparatus, transmit second network information concerning wireless communication between the communication apparatus and the external access point to the external server, and
the information processing apparatus comprises:
at least one memory and at least one processor which function as:
a first acquisition unit configured to, in a case where it is impossible to execute wireless communication with a communication apparatus via the external access point, acquire, from the information processing apparatus, first network information concerning wireless communication between the information processing apparatus and the external access point;
a first request unit configured to, in a case where it is impossible to execute wireless communication with the communication apparatus via the external access point but wireless communication with the external server can be executed, request the second network information transmitted to the external server by the transmission unit from the external server; and
a notification unit configured to make a notification for executing wireless communication with the communication apparatus via the external access point based on at least one of the first network information and a response result to the request.
